(19) United States
(12) Patent Application Publication
(10) Pub. No.: US 2005/0025383 A1
(43) Pub. Date: Feb. 3, 2005

(54) Image sharpening with region edge sharpness correction

(75) Inventors: Carlos Domingo, Tokyo (JP); Takeshi Sukegawa, Saitama-ken (JP); Takashi Kawasaki, Setagaya-ku (JP); Keita Kamiya, Suginamiku (JP); Artem Mikheev, New York, NY (US)

Correspondence Address: BANNER & WITCOFF, 1001 G STREET N W, SUITE 1100, WASHINGTON, DC, 20001, US

(73) Assignee: Celartem Technology, Inc., Minato-ku (JP)

(21) Appl. No.: 10/882,662

(22) Filed: Jul. 2, 2004

Related U.S. Application Data
(60) Provisional application No. 60/483,900, filed on Jul. 2, 2003.
(60) Provisional application No. 60/483,925, filed on Jul. 2, 2003.

(51) Int. Cl. G06K 9/00

(52) U.S. Cl. 382/266

(57) ABSTRACT

A system and process for improving image quality is described. The process uses an edge map to smooth colors based on at least one of how close a pixel is to an edge and the strength of the edge.

### RELATED APPLICATION INFORMATION

This application claims priority to U.S. Ser. No. 60/483,900, entitled “Image Sharpening with Region Edge Sharpness Correction” to Mikheev, Domingo, Sukegawa, and Kawasaki, filed Jul. 2, 2003, and to U.S. Ser. No. 60/483,925, entitled “Image Sharpening with Region Edge Sharpness Correction” to Mikheev, Domingo, Sukegawa, and Kawasaki, filed Jul. 2, 2003. The contents of both of these applications are expressly incorporated herein by reference as to their entireties.

### BACKGROUND OF THE INVENTION

1. Technical Field

Aspects of the present invention relate to image processing. More particularly, aspects of the present invention relate to image sharpening methods that correct at least one of region edge sharpness, its perceived geometrical shape, and region edge contrast. Moreover, these image sharpening methods are suitable for application where the images to be sharpened are images that have been previously magnified using conventional scaling methods.

2. Related Art

Digital image processing is becoming increasingly popular as consumers replace film-based cameras with digital ones. Also, artists are using digital canvases to create works on-screen, rather than by more conventional hand drawing or painting. Another popular method for obtaining digital images is by scanning existing art work into a digital representation or form. While the digital medium provides flexibility in what one can do, it is limited by the resolution of the image (resolution may be referred to here as the total number of pixels in the digital image) and this is typically tied to the quality of the media that has been used to generate the image (the resolution of the digital camera or scanner used, for instance). Most common graphical processing tools provide a set of filters to try to improve the perceived quality of a digital image, like its contrast or the brightness. Other well known methods for improving the perceived quality of a digital image are sharpening filters. These filters are used to improve the sharpness of blurred images. Other way of increasing the resolution of an image is by scaling it to a larger size by generating new pixels.

Perhaps the most common use of a sharpening filer is as a post processing filter for an image that has been enlarged. Image magnification processes typically involve some artificial method of creating new information out of existing information while attempting to preserve the amount of information perceived by a user. Common processes for enlarging an image include replacing each pixel with a number of identical pixels. For example, for a magnification of 4, one would replace each pixel with sixteen pixels. Other more sophisticated magnification processes are possible and usually involve processing the color information of neighboring pixels to create a new one. These methods are typically called interpolation methods, the most popular being bilinear and bicubic interpolation.

One issue with interpolating algorithms is that they tend to generate images that appear blurry, in particular, around region edges since they tend to blend a set of neighboring pixels together. Sharpening filters are a commonly used solution for this issue. While sophisticated sharpening methods like the so called “Unsharp Mask” that can be found in most common image processing tools tend to improve the overall blurriness of an image and increase the contrast around certain edges, they generally do not improve the edge geometry and effectively remove the jaggedness that appear in the original image. Accordingly, a new process for image sharpening that works well on images with blurred and jagged edges is needed.

### BRIEF SUMMARY

Aspects of the present invention address one or more issues described above, thereby providing an improved image sharpening process, thereby producing better resultant images. Aspects of the invention determine edges of the image. Next, as preferred embodiments, a transparency weight and a confidence weight map of the image colors may be created using the previously obtained edge information. Finally, a constrained convolution respecting the edge boundaries may be performed, and a resulting image is produced. These and other aspects of the invention are described below.

### BRIEF DESCRIPTION OF THE DRAWINGS

FIG. 1A shows a source image with blurred and jagged. FIG. 1B shows a result image of sharpening of prior art. FIG. 1C shows image after filtering in accordance with aspects of the present invention.

FIG. 2 shows an example of a pixilated and jagged edge and a smoothed one.

FIGS. 3A-3E show examples of edge, blocked and free image areas in accordance with aspects of the present invention.

FIGS. 4A and 4B show an example of the application of the edge constraint convolution to a blocked pixel in accordance with aspects of the present invention.

FIG. 5 shows a description of the transparency weight concept in accordance with aspects of the present invention.

FIGS. 6A and 6B show an example of the different influence of pixels depending on their relative position with respect to an edge in accordance with aspects of the present invention.

FIG. 7 shows the flow of the sharpness algorithm in accordance with aspects of the present invention.

FIGS. 8A and 8B show transparency weight calculations in accordance with aspects of the present invention.

FIGS. 9A and 9B show confidence weight calculations in accordance with aspects of the present invention.

FIGS. 10A and 10B describe a convolution base weight function in accordance with aspects of the present invention.

FIGS. 11-19 show various additional approaches to sharpening an image in accordance with aspects of the present invention.

FIGS. 20-22C show an optional approach of using a reverse edge strength map in accordance with aspects of the present invention.

FIG. 23 shows a flowchart of an aspect of the invention with representative images.

### DETAILED DESCRIPTION OF THE DRAWINGS

Aspects of the present invention relate to sharpening of blurred and jagged images. The following description is divided into sections to assist the reader: overview of image sharpening; image sharpening processes; details of various embodiments; terms; edge constraint convolution; convolution base weight; edge detection with smoothing; transparency weight calculation; confidence map construction; product of transparency and confidence; and additional processes.

Overview of Image Sharpening

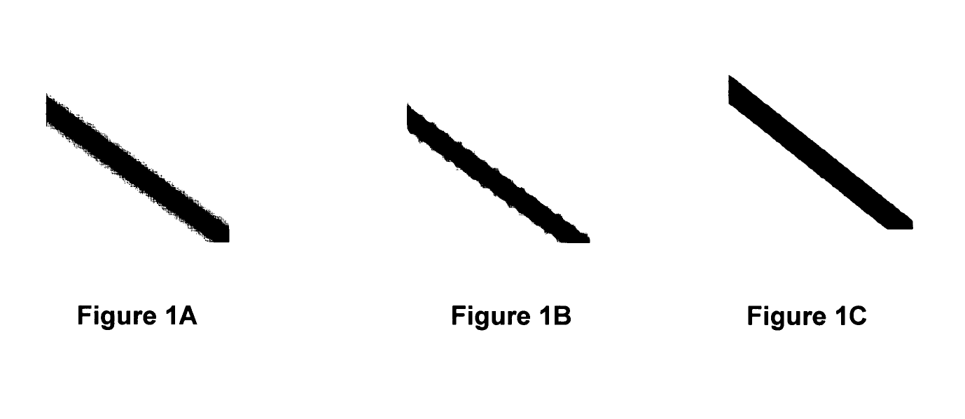

Images that are blurred or contain jagged edges may be enhanced by using a sharpening filter. Advance sharpening algorithms, while removing part of the blurredness of an image, do not remove the jaggedness of the image. This is particularly obvious when the sharpening filer is applied to images that have previously been scaled using a standard image scaling algorithm based on interpolation methods like bicubic or bilinear. FIG. 1A shows an image of a line that has been scaled 800% with bilinear interpolation. The line is not only blurred but also contains obvious jagged edges. FIG. 1B shows a common approach to solve this issue where an unsharp mask filter has been applied to improve the sharpness of the image. While the overall image sharpness has been improved and the blurriness partially removed, the edges continue to be jagged. FIG. 1C shows an example of a result of the sharpness algorithm that not only removes the image blurriness but also the jagged edges. FIG. 1C has been generated in accordance with one or more aspects of the present invention from the image in FIG. 1A.

At least some aspects of the present invention attempt to increase the overall image sharpness by removing the blurriness of an image as well as correct jagged edges. Aspects of the present invention may use various combinations of an edge detection, confidence map and transparency weights, and convolution based on region edge constraints from the edge detection to accomplish this.

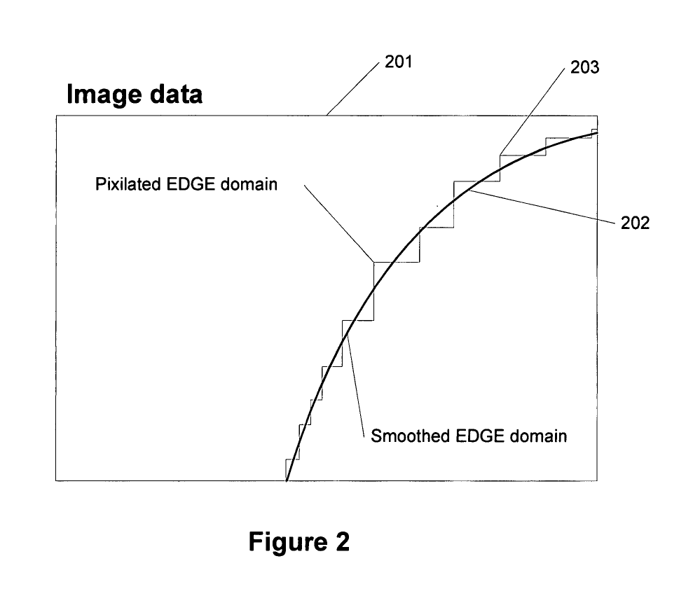

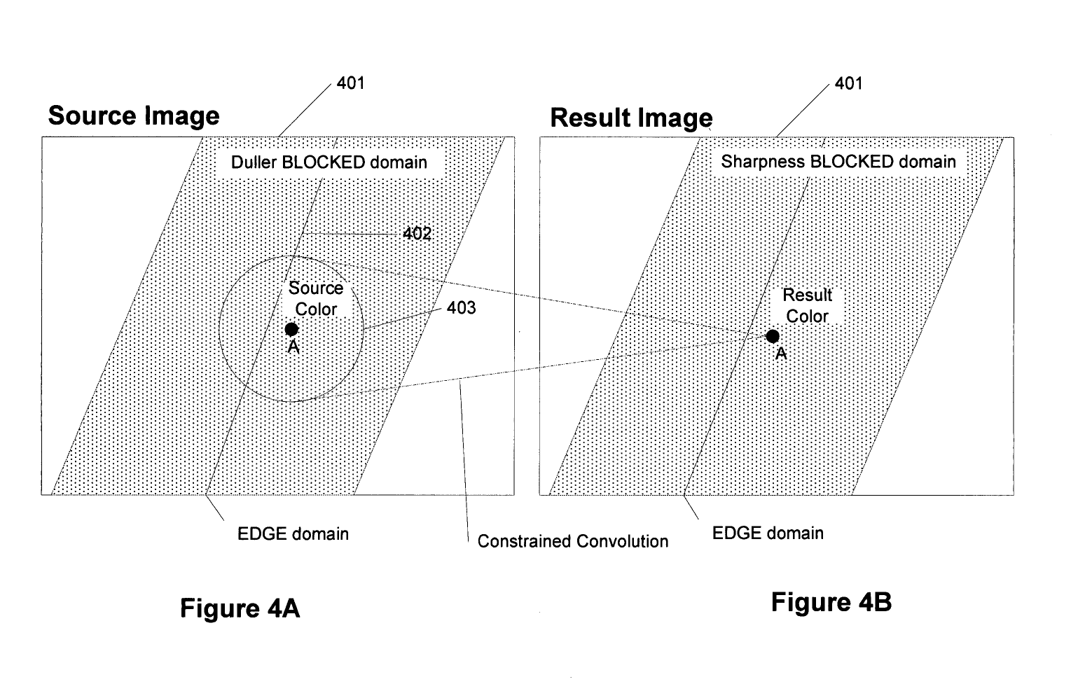

Image sharpness that preserves and corrects blurred, pixilated and/or jagged edges can be achieved using one or more aspects of the present invention. The following is a summary of four main points. It is appreciated that aspects of the invention may be implemented with less than all of the following points:
I. An edge map of an image can be created to determine in which areas of the images some pixel colors need to be recreated. Moreover, if a smoothing process is applied previous to the edge map creation, very fine and smooth edges can be obtained even if the image has pixilated and/or contains jagged edges. FIG. 2 shows a diagram of a smooth edge obtained from a pixilated edge.
II. To improve the quality of an image with blurred and jagged edges, a convolution can be applied to the pixels that fall into an edge area (either an edge or the vicinity of an edge) so that a blurred pixel can be regenerated by combining surrounding pixel colors where each pixel color is weighted with respect to certain weights determined by its position relative to the edge information of the image. FIGS. 4A and 4B show an example of a pixel in a blurred area near an edge and how a convolution is applied to regenerate that pixel color by using its neighboring pixels with the edge information.
III. In one embodiment of the edge information, when determining the influence of a reference pixel's color on a reconstruction pixel's color (in, for instance, a convolution), the determination may include whether the reference pixel lies on the other side of a region edge in the image from the reconstruction pixel. This is because an edge has the characteristic that a color greatly changes in the boundary. When this information is used with the convolution, blurry noise can be repressed.
IV. In one embodiment of the edge information, when determining the certainty of a reference pixel color in region edge of an image, the distance of that pixel to an edge is another factor because a position of a boundary of a reference color information, which has jagged noise, does not correspond to a position of a smoothed edge information. Even reference pixel located at the same side of the edge line, the possibility that it has a different color if it is close to an edge is high. The confidence of the color of a reference pixel is lower the nearer it is to a region edge of the image. In other words, the confidence of the correctness of the color of a reference pixel may be a monotonously decreasing function of the distance to the nearest region edge. When this information is used with the convolution, a blurry and jagged noise can be repressed.
   Image Sharpening Processes

FIG. 2 shows an example where an image 201 contains a very jagged and pixilated edge 203. A smoothing process can be applied to remove the pixilation noise to the image. Then, a general edge detection process can be applied. FIG. 2 shows the resulting smooth edge 202 that can be obtained by following one or more processes described herein.

FIGS. 4A and 4B show how a convolution can be applied to reconstruct the color of a pixel in a blurred area next to an edge. Here, a pixel A of image 401 near an edge domain 402 in FIG. 4A uses color values from pixels in a surrounding aperture 403 to determine a resulting color of pixel A as shown in FIG. 4B.

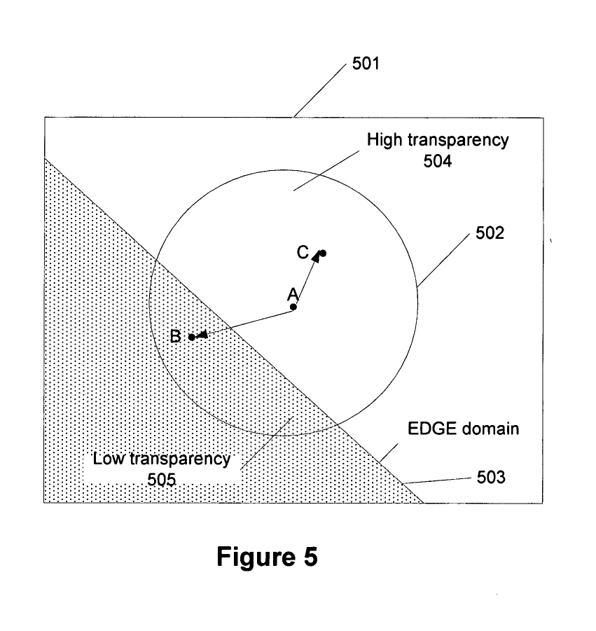

FIG. 5 shows an image 501 with three pixels, A, B and C. A reconstructing pixel A is centered in an aperture 502 and there is an edge 503 (straight line) that lies between pixel A and pixel B, which has reference color. The region 504 that lies in the same edge side as pixel A is said to have high transparency (no edge blocks any pixels from pixel A). However, the region 505 that lies in the opposite side of the edge 503 from pixel A is said to have low transparency. Similarly, a transparency weight can be defined for each pixel in the aperture centered in pixel A. In that case, the transparency weight of pixel C will be large while the transparency weight of pixel B will be low. Therefore, when applying a convolution to pixel A, the weight of pixel B will be low and its color will have a low impact on the new color being recreated for pixel A. On the other hand, the color of pixel C will have a large weight and its color will have more influence on the new color of pixel A.

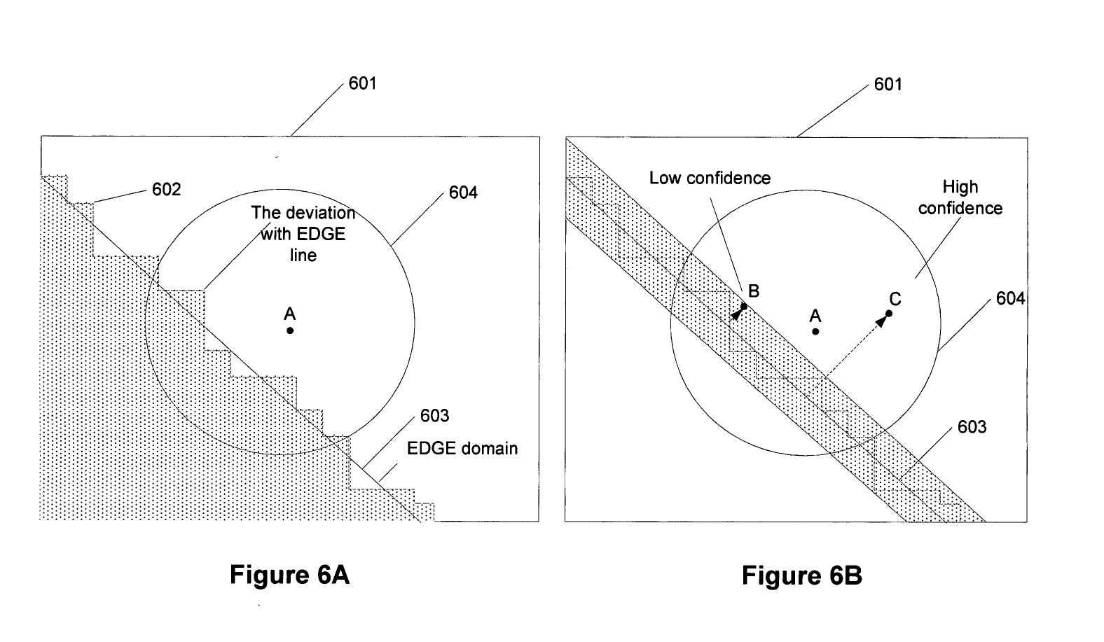

FIG. 6A shows an image 601 with a jagged edge 602 and the ideal sharp underlying edge 603. As it can be seen, some pixels close to the edge have a wrong color since the jagged edges cross the edge 603 repeatedly. Therefore, the reference color of pixels close to a jagged edge 602 cannot be really determined with high accuracy. FIG. 6B shows an image where there is an aperture 604 centered in reconstructing pixel A. A reference pixel B lies in an area that is close to an edge and therefore its reference color cannot be determined with accuracy. In this case, the color of that pixel B has low confidence. On the other hand, reference pixel C lies in an area far enough from the edge 603 and therefore one can accept its reference color with high confidence. When applying a convolution to pixel A to reconstruct its color, a reference pixel B should have less influence on pixel A's new color (since pixel B will have a low confidence weight) than a reference pixel C (that will have a high confidence weight).

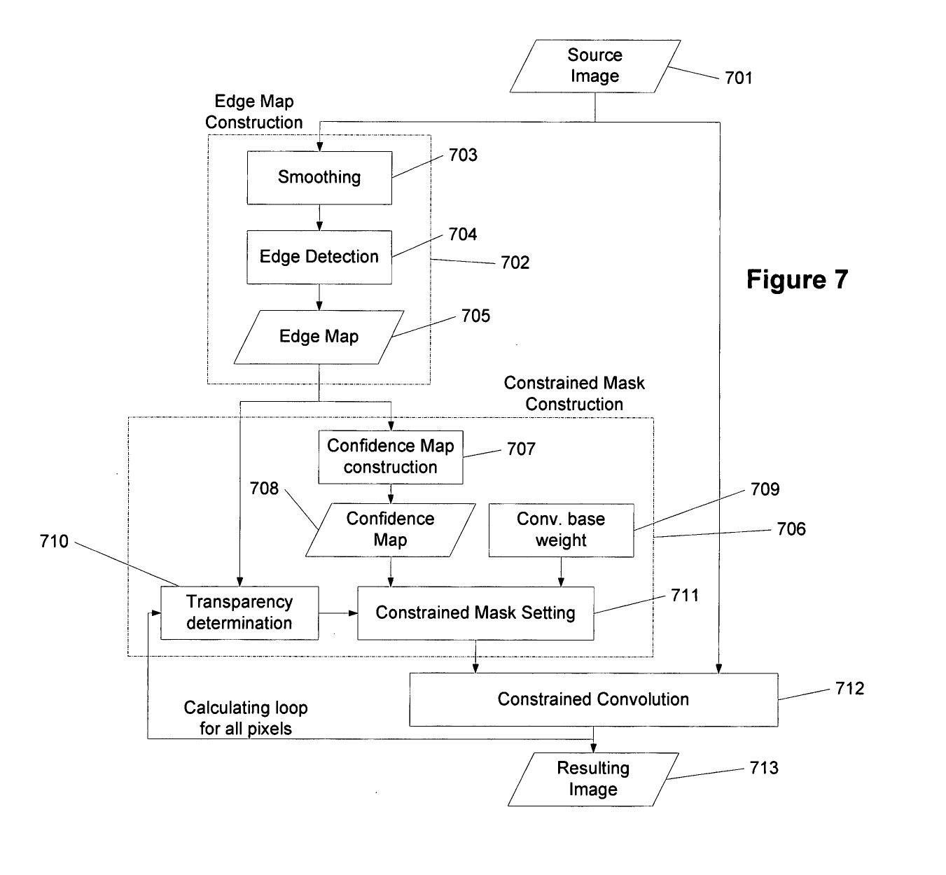

FIG. 7 shows a process for image sharpening with region edge preservation in accordance with aspects of the present invention. A source image 701 is processed. First, an edge map is created in step 702. Sub steps 703 and 704 are shown within step 702. A smoothing filter is applied in step 703. Next, in step 704, an edge detection 704 is performed, resulting in edge map 705.

Next, the constrained mask construction is performed in step 706. First, a confidence map is constructed in step 707, resulting in confidence map 708. The edge map 705 is also used to determine the level of transparency for each pixel in step 710. The transparency determination 710 is combined with the confidence map 708 and a convolution base weight 709 in the constrained mask setting 711. A convolution base weight (as described below) is a weight applied to pixels based on a distance from a given pixel. With a convolution base weight, closer pixels have more influence on a given pixel's color; farther pixels have less influence on a pixel's color.

Finally, the constrained mask setting 711 is combined with the original source image 701 to reference a color in a constrained convolution 712, producing the resulting image 713. The system loops back to step 710 to determine the convolution for all pixels.

Details of Various Embodiments

Terms

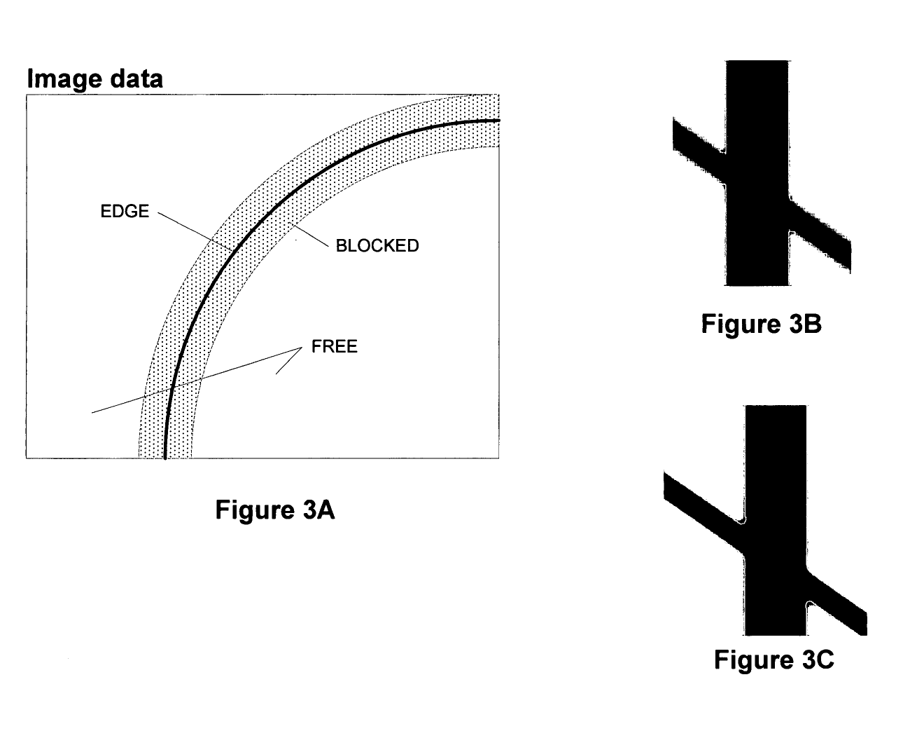

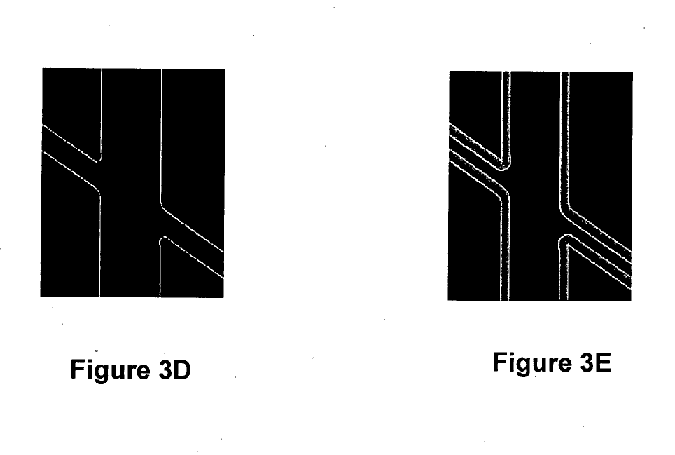

EDGE domain: An edge extracted from a given image after using a certain edge detection process. In particular, an edge detection process that obtains very thin and smooth edges is useful. One way to achieve this is by applying a smoothing process before an edge detection algorithm is applied. FIG. 3A shows an example of an edge domain of an image. FIGS. 3B and 3D shows an image with blurred and jagged edges and the resulting edge domain (line pixels are in the edge domain while black pixels are not) obtained after applying a smoothing and edge detection process.

BLOCKED domain: This domain is defined as the set of pixels within a certain distance from an edge. The distance from the edge is referred as the “Influence Radius” of the edge. The pixels in the blocked domain are the pixels that are improved by the Constrained Convolution described below. Typically, one should select an “Influence Radius” large enough so that all the jagged pixels from an edge are contained within the blocked domain. FIG. 3A shows an example of a blocked domain of an image. FIG. 3E shows an edge domain of an image and its corresponding blocked domain.

FREE domain: This domain contains all the pixels that are neither on an edge domain nor in a blocked domain. FIG. 3A shows an example of a free domain as well as FIG. 3E (free domain pixels are in grey in the image). Constrained convolution is not being applied to pixels in the free domain since those pixels do not require any correction.

Image Data: Given an image I of dimensions n, m. Each pixel of the image is referred to as p_{x,y}=(x, y) where 0≦x<n and 0≦y<m. (p is an abbreviation for p_{x,y}).

Aperture of an image: Given an image I and a pixel p₀ ε I, a circular aperture Aₚ_{₀}_{,R}⊂I of radius R is the set of pixels that are at Euclidean distance at most R from center pixel p₀. (A is an abbreviation for Aₚ_{₀}_{,R}).

Edge Map: For a given image I, an edge map E_{σ} includes of a set of weights for each pixel of the image. The parameter σ shows level (standard deviation of gauss filter) of smoothing to remove jagged and/or pixilated noise. Given pixel p ε I, its weight in edge map E_{σ} is represented by e_{σ}(p). (E is an abbreviation for E_{σ}, and e(p) is an abbreviation for e_{σ}(p).)
e_{σ}(p)εE_{σ}
Edge Constraint Convolution

The edge constrained convolution determines which new color values should be applied to each pixel.

The edge constrained convolution includes the steps of a detection of edge strength information in source image and a convolution based on a detected edge information.

When w_{E} is made the edge information, the convolution is expressed as:

$$NewColor ( {p}_{0} ) = {\sum }_{i , j = - R , … , R} \{ Color ( {p}_{i , j} ) \times \frac{{w}_{E} ( {p}_{i , j} ) \times {w}_{R} ( {p}_{i , j} )}{norm ( {w}_{E} ( {p}_{i , j} ) , {w}_{R} ( {p}_{i , j} ) )} \}$$

where p₀ indicates a pixel in coordinates (x₀, y₀) in source or/and resulting image. NewColor(p₀) indicates the color value of target pixel p₀ in resulting image, Color(p_{i,j}) indicates the color value of pixel p_{i,j} in the surroundings of pixel p₀ in source image, R indicates the radius of the convolution mask, p_{i,j} indicates a pixel with coordinate (x₀+i,y₀+j),(i,j)ε[−R,R] in the convolution mask, w_{E}(p_{i,j}) indicates weight edge information of the image, w_{R}(p_{i,j}) indicates a base weight for pixel of source image in the convolution, an norm(w_{E}(p_{i,j}), w_{R}(p_{i,j})) indicates the norm of w_{R}(p_{i,j}) and w_{E}(p_{i,j}).

The edge constrained convolution may be only applied to pixels in a blocked domain. When a pixel belongs to the free domain, the constrained convolution can be substituted by an ordinary convolution that averages the pixels colors with a weight that declines as the distance to the pixel being considered increases.

Convolution Base Weight

For the convolution based weight, there are many choices that one can make. One possible function to use is a base linear weight w_{R}(p) that for any p_{i,j}=(i,j)ε[−R,R] is defined as follows:

$${w}_{R} ( {p}_{i , j} ) = \{ \begin{matrix}1 - α \cdot \frac{\sqrt{{i}^{2} + {j}^{2}}}{R} , {i}^{2} + {j}^{2} < {R}^{2} \\ 0 , {i}^{2} + {j}^{2} \geq {R}^{2}\end{matrix} \\ ∵ α > 0$$

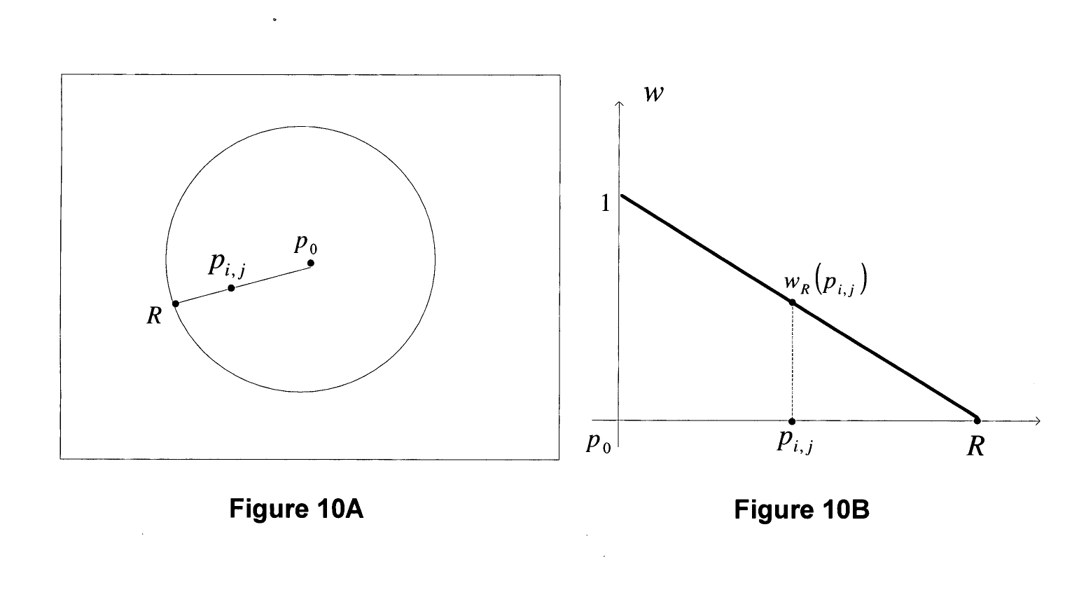

FIGS. 10A and 10B show a geometrical interpretations of the convolution based weight that is defined above.

Another possible function to use for a convolution base weight is a base bilinear weight w_{R}(p) that for any p_{i,j}=(i,j)ε[−R,R] is defined as follows:

$${w}_{R} ( {p}_{i , j} ) = \{ \begin{matrix}1 - α \cdot \frac{\vert i \vert + \vert j \vert}{R} , {i}^{2} + {j}^{2} < {R}^{2} \\ 0 , {i}^{2} + {j}^{2} \geq {R}^{2}\end{matrix} \\ ∵ α > 0$$

Yet another possible function to use is for a convolution base weight a base hemisphere weight w_{R}(p) that for any p_{i,j}=(i,j)ε[−R,R] is defined as follows:

$${w}_{R} ( {p}_{i , j} ) = \{ \begin{matrix}\sqrt{1 - \frac{{α}^{2} \cdot ( {i}^{2} + {j}^{2} )}{{R}^{2}}} , {i}^{2} + {j}^{2} < {R}^{2} \\ 0 , {i}^{2} + {j}^{2} \geq {R}^{2}\end{matrix} \\ ∵ α > 0$$

A further possible function to use for a convolution base weight is a base Gaussian weight w_{R}(p) that for any p_{i,j}=(i,j)ε[−R,R] is defined as follows:

$${w}_{R} ( {p}_{i , j} ) = \{ \begin{matrix}\frac{1}{2 {πσ}^{2}} \cdot exp ( - \frac{{i}^{2} + {j}^{2}}{2 {σ}^{2}} ) , {i}^{2} + {j}^{2} < {R}^{2} \\ 0 , {i}^{2} + {j}^{2} \geq {R}^{2}\end{matrix} \\ ∵ α > 0$$

Another possible function to use for a convolution base weight is a base sinc weight w_{R}(p) that for any p_{i,j}=(i,j)ε[−R,R] is defined as follows:

$${w}_{R} ( {p}_{i , j} ) = \{ \begin{matrix}\frac{sin ( α \cdot π \sqrt{{i}^{2} + {j}^{2}} / R )}{( α \cdot π \sqrt{{i}^{2} + {j}^{2}} / R )} , {i}^{2} + {j}^{2} < {R}^{2} \\ 0 , {i}^{2} + {j}^{2} \geq {R}^{2}\end{matrix} \\ ∵ α > 0$$

Another possible function to use for a convolution base weight is a base bicubic weight w_{R}(p) that for any p_{i,j}=(i,j)ε[−R,R] is defined as follows:

$$x ( i ) = \{ \begin{matrix}1 - 2 {( α \cdot \vert i \vert )}^{2} + {( α \cdot \vert i \vert )}^{3} , 0 \leq α \cdot \vert i \vert < 1 \\ 4 - 8 ( α \cdot \vert i \vert ) + 5 {( α \cdot \vert i \vert )}^{2} - {( α \cdot \vert i \vert )}^{3} , 1 \leq α \cdot \vert i \vert < 2 \\ 0 , 2 \leq α \cdot \vert i \vert\end{matrix} \\ y ( j ) = \{ \begin{matrix}1 - 2 {( α \cdot \vert j \vert )}^{2} + {( α \cdot \vert j \vert )}^{3} , 0 \leq α \cdot \vert j \vert < 1 \\ 4 - 8 ( α \cdot \vert j \vert ) + 5 {( α \cdot \vert j \vert )}^{2} - {( α \cdot \vert j \vert )}^{3} , 1 \leq α \cdot \vert j \vert < 2 \\ 0 , 2 \leq α \cdot \vert j \vert\end{matrix} \\ {w}_{R} ( {p}_{i , j} ) = \{ \begin{matrix}x ( i ) xy ( j ) , {i}^{2} + {j}^{2} < {R}^{2} \\ 0 , {i}^{2} + {j}^{2} \geq {R}^{2}\end{matrix} \\ ∵ α > 0$$

It is appreciated that any one of these approaches may be used alone or in combination to determine a convolution base weight.

Edge Detection with Smoothing

Various edge detection approaches may be used. However, to achieve highest quality, a smoothing process for images with blurred and jagged edges should be applied. Smoothing is typically done before Edge Detection but may be performed after as well. An edge is made tidy and continuous as a result of applying that process. The size of the smoothing mask should be decided taking into account the level of pixilation. In particular, the smoothing mask should reach all the pixels that are within the jagged edges. Various smoothing processes are known in the art.

After smoothing has been performed, an edge detection process is applied. This process takes as input the image produced by the smoothing process and produces a weighted edge map of the image. A weighted edge map includes a weight between 0 and 1 for each pixel of the input image where the closest to 1, the stronger the edge, with 0 meaning that the pixel is neither an edge nor close to one. The edge strength information is looked for first. Next, a ridge is extracted from the edge strength information. This edge line information is called edge map. This step can be implemented using any edge detection algorithm like the well known Canny Edge detection among others.

FIG. 3B shows an image with blurred and jagged edges. FIG. 3D shows the edge map generated after a smoothing step and an edge detection process has been applied.

Transparency Weight Calculation

When restoring the color of a pixel using the constrained convolution, one should generally avoid taking into account pixel colors that are in the opposite side of an edge from the pixel color being calculated. Therefore, low weights should be assigned to pixels lying on the other side of edges from the pixel whose color is being calculated. This concept is captured in the definition of transparency weight. The processing of pixel values in the constrained convolution is based on the weight of transparency level, namely, whether they are on the same or different side of an edge.

In one embodiment of an edge information, the transparency weight τ(p_{i,j}) may be expressed as:
w_{E}(p_{i,j})=(τ(p_{i,j}))=1−ƒ(p₀,p_{i,j},e(p))
where p₀ indicates a pixel which is regenerated by the convolution centered in (x₀, y₀), p_{i,j} indicates a pixel in coordinates (x₀+i,y₀+j) whose weight is being calculated, pε\overline{p₀p_{i,j}} indicates any pixel lying on a straight line from pixel p₀ to pixel p_{i,j}, e(p) indicates edge strength at a pixel p, ƒ( ) indicates a function whose values are between 0 and 1 and that for any two p₀ and p_{i,j} is continuous and monotonically increasing with respect to p.

The level of transparency may be based on other factors including the distance of a pixel to the region edge, the distance of the pixel to the center of the aperture, and the like.

As an example of a function of the transparency weight that is expressed as a rectangle function, which has a maximum at the pixel with the maximum edge strength, the weight may be expressed as:

$$τ ( {p}_{i , j} ) = \{ \begin{matrix}1 , r \leq {r}_{e} \\ 1 - {\underline{max}}_{p ∈ {p}_{o} {p}_{i , j}} e ( p ) = 1 - e ( {p}_{e} ) , {r}_{e} < r \leq R\end{matrix}$$

where pε\overline{p₀p_{i,j}} indicates any pixel lying on a straight line from pixel p₀ to pixel p_{i,j}, e(p) indicates the edge strength between 0 and 1 at pixel p, pₑ⊂ p indicates the pixel with maximum edge strength and e(pₑ) indicates its edge strength between 0 and 1, r=|\overline{p₀p_{i,j}}| indicates a distance metric between pixel p₀ and pixel p_{i,j}, rₑ=|\overline{p₀pₑ}| indicates a distance metric between pixel p₀ and pixel pₑ and R indicates the radius of the convolution mask.

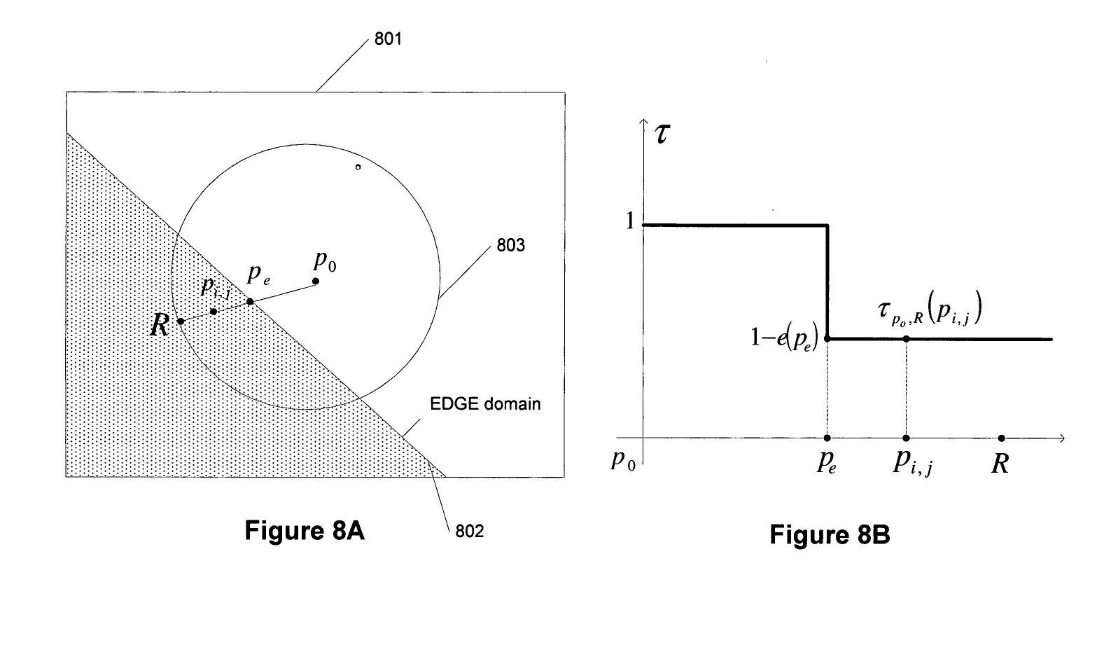

FIGS. 8A and 8B show a geometrical interpretation of the above formula in accordance with aspects of the present invention. In image 801, on near side of edge 802 to pixel p₀, the pixels in aperture 803 have a transparency of 1. On the other side, they have a transparency determined by the edge strength (here, 1−e(pₑ)). This is shown graphically as FIG. 8B. This may be alternately expressed as 1−e(pₘₖ) or 1−e(pₙₖ) in a more general form.

In another example, the level of transparency may be related to a rectangle function that has a transition at a nearest pixel that has a bigger edge strength than a threshold. The weight may be expressed as:

$$τ ( {p}_{i , j} ) = \{ \begin{matrix}1 , r \leq {r}_{e} \\ 1 - e ( {p}_{e} ) , {r}_{e} < r \leq R\end{matrix}$$

At this equation, pₑε\overline{p₀p_{i,j}} indicates the nearest pixel, which has bigger edge strength than a threshold from each center pixel p₀, which is regenerated by a convolution to a pixel p_{i,j} which weight is given to an image, e(pₑ) indicates the edge strength which consists of between 0 and 1 at the pixel pₑ, r=|\overline{p₀p_{i,j}}| indicates a distance from a pixel p₀ to a pixel p_{i,j}, rₑ=|\overline{p₀pₑ}| indicates the distance from a pixel p₀ to the pixel pₑ, and R indicates the radius of the convolution mask.

In another example, the level of transparency may be based on other factors including the distance of a pixel to the region edge, the distance of the pixel to the center of the aperture, and the like the weight is expressed as:

$$τ ( {p}_{i , j} ) = \{ \begin{matrix}1 , r \leq {r}_{e} \\ 0 , {r}_{e} < r \leq R\end{matrix}$$

Here, r=|\overline{p₀p_{i,j}}| indicates a distance from a pixel p₀, which is regenerated by a convolution at the coordinate of (x,y) to a pixel p_{i,j}, which weight is given to, rₑ=|\overline{p₀pₑ}| indicates the distance from each pixel p₀ to the pixel pₑ, which is the nearest pixel which has bigger edge strength than a threshold from the p₀, or which has the maximum edge strength on a line from a pixel p₀ to a p_{i,j}, and R indicates the radius of the convolution mask.

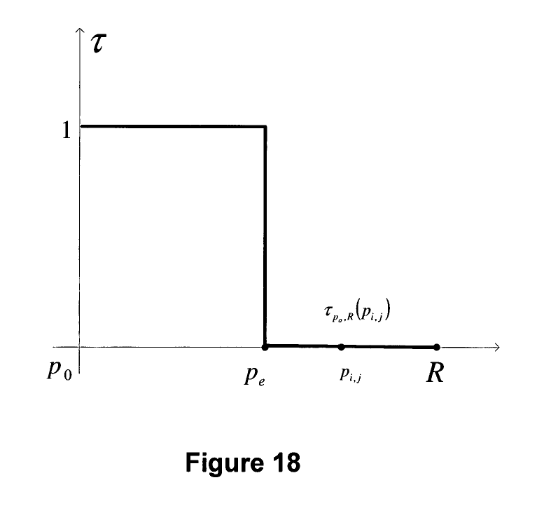

FIG. 18 shows a geometrical interpretation of the transparency weight that is defined above. This approach provides a simpler approach to that of FIG. 8B. The transparency weight may be based on the nearest pixel that has a larger edge strength than a threshold or a maximum edge strength.

In yet another example, the level of transparency may be based on other factors including the distance of a pixel to the region edge, the distance of the pixel to the center of the aperture, and the like. For more than one edge line, when it gets over and the weight declines gradually the weight may be expressed as:

$$τ ( {p}_{i , j} ) = \{ \begin{matrix}1 , r \leq {r}_{e} \\ 1 - {\sum }_{p ∈ \overline{{p}_{0} p}}^{} e ( {p}_{e} ) , {r}_{e} < r \leq R\end{matrix}$$

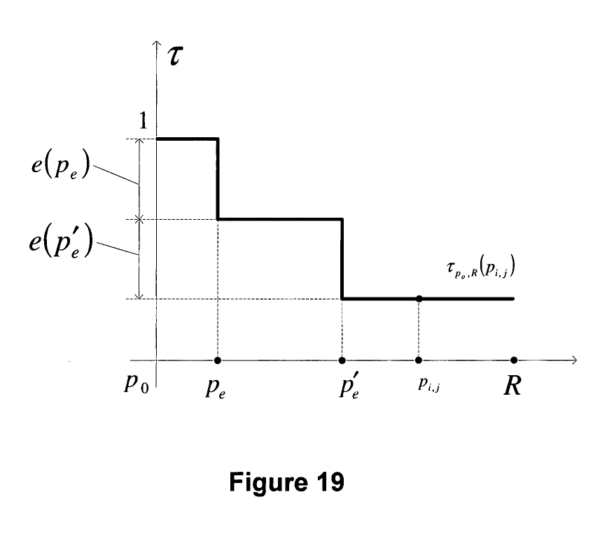

FIG. 19 shows a geometrical interpretation of the transparency weight that is defined above. FIG. 19 shows an example where there are two edges. Of course, more than two edges may exist within radius R. If that situation, the above equation addresses the different edge strengths and drop in transparency.

Further, these transparency weights may be used or in combination.

Confidence Map Construction

Using the edge map generated, one may construct a confidence map that represents the probability of a pixel representing a valid color in the image. Fluctuations of color are very strong near the color edges, in particular for images with pixilation, blurred and jagged edges. Therefore, confidence of the pixels is generally decreasing the closer one approaches the region edges.

Because of this, unreliable color information for those pixels might greatly affect the calculation of new color pixels when applying the sharpening process. The domain that might be affected by this pixilation noise is referred to as a Low Confidence Domain. The extent of the low confidence domain is determined by the so called Confidence Radius. When applying a convolution to reconstruct a pixel color, one should assign a low weight to the pixels in the Low Confidence Domain.

In one embodiment of an edge information, the confidence weight ν(p_{i,j}) may be expressed as:
w_{E}(p_{i,j})=(ν(p_{i,j}))=1−ƒ′(p_{i,j},e(p(r_{c})))
where p_{i,j} indicates a pixel in coordinates (x₀+i,y₀+j) for which the weight is being calculated, p(r_{c}) indicates pixel with non zero edge strength e(p(r_{c})) at distance r_{c} from pixel p_{i,j} of said image, and ƒ′( ) indicates a function with values between 0 and 1 that for a given pixel p_{i,j} is continuous and monotonically increasing in e(p(r_{c})).

The above formula describes how to calculate the confidence of each pixel in the source image. It is important to notice that the calculation of the confidence weight, and therefore the creation of the confidence map, is independent of the convolution that may be applied later to create a new color for each pixel.

An example of a function of the confidence weight is defined in terms of a linear function and the weight is expressed as:

$$\begin{matrix}υ ( {p}_{i , j} ) = \{ \begin{matrix}1 - max ( e ( p ( {r}_{c} ) ) \times ( 1 - \frac{{r}_{c}}{{R}_{c}} ) ) , 0 < {r}_{c} \leq {R}_{c} \\ 1 , {R}_{c} \leq {r}_{c}\end{matrix} \\ ∵ {r}_{c} = \sqrt{{i}^{2} + {j}^{2}}\end{matrix}$$

where r_{c}=|\overline{p_{i,j}p(r_{c})}| indicates a distance from pixel p_{i,j} at coordinates (x₀+i,y₀+j) whose weight is being calculated to pixel p(r_{c}) with non zero weight strength e(p(r_{c})) between 0 and 1 and R_{c} indicates the radius of the influence of edge.

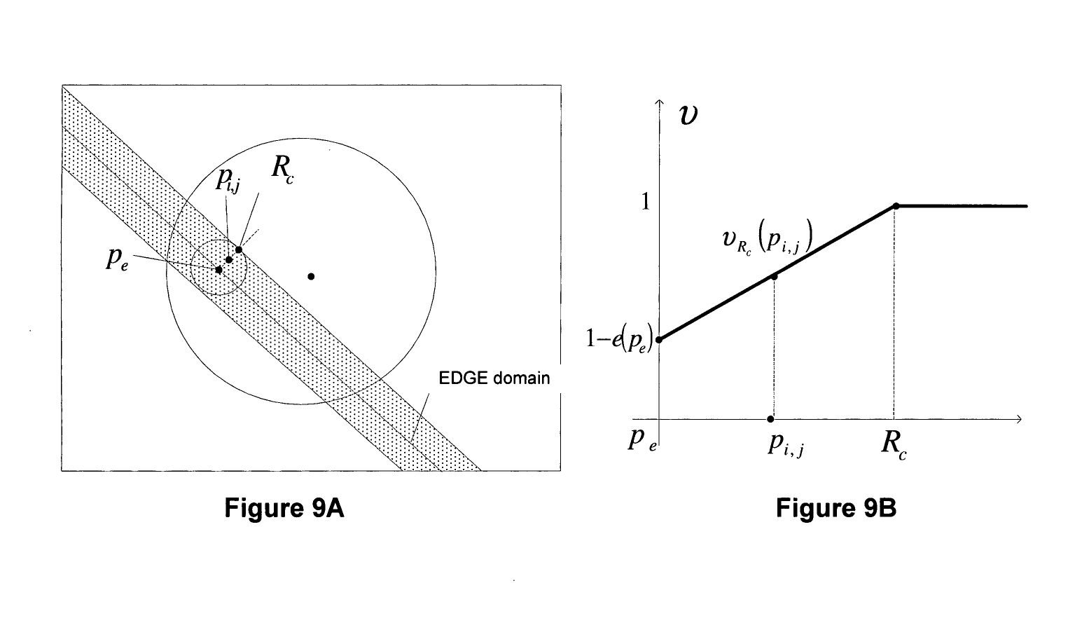

FIGS. 9A and 9B show a geometrical interpretation of the confidence weight formula described above. In FIG. 9A, for each pixel p_{i,j}, its confidence weight is determined by its proximity to edge (defined by pixels pₑ). In FIG. 9B, the confidence of the color of a pixel is inversely proportional to the strength of a region edge next to it. With no edge (edge strength=0), the system has a high confidence in the color value of the pixel. With a strong edge (edge strength=1), the confidence drops to zero.

The confidence weight ν(p_{i,j}) can change coefficient by using various formulae. A general formula of confidence is defined as follows:

$$υ ( {p}_{i , j} ) = \{ \begin{matrix}min ( {F}_{c} ( p ) ) , p ∈ A \\ 1 , p ∉ A\end{matrix} ∵ {F}_{c} ( p ) = \{ \begin{matrix}1 , 1 \leq {f}_{c} \\ {f}_{c} ( p ) , 0 < {f}_{c} < 1 \\ 0 , {f}_{c} \leq 0\end{matrix}$$

The confidence coefficient of F_{c}(p) decrease monotonically. Then, it may be shown with various piecewise polynomial functions. Some examples follow of the function F_{c}(p), ƒ_{c}(p) and p=(i,j) in which the formula elements are enumerated.

In another example of a function of the confidence weight, edge strength amplification is shown. Edge strength amplification may be used when edges are weak and/or where pixel color mixing occurs where it should not. Edge strength amplification increases the strength of edges so as to prevent the influence of pixels near an edge on other pixels. In the basic formula of confidence weight, e(pₑ) is amplified by α coefficient as a simple application. But, value of this function is made 0 when α×e(pₑ) exceeds 1. the weight may be expressed as:

$$\begin{matrix}{f}_{c} ( {p}_{i , j} ) = 1 - α \cdot e ( {p}_{e} ) - α \cdot e ( {p}_{e} ) \cdot \frac{\sqrt{{i}^{2} + {j}^{2}}}{{R}_{c}} \\ = 1 - α \cdot e ( {p}_{e} ) \times ( 1 - \frac{\sqrt{{i}^{2} + {j}^{2}}}{{R}_{c}} )\end{matrix}$$

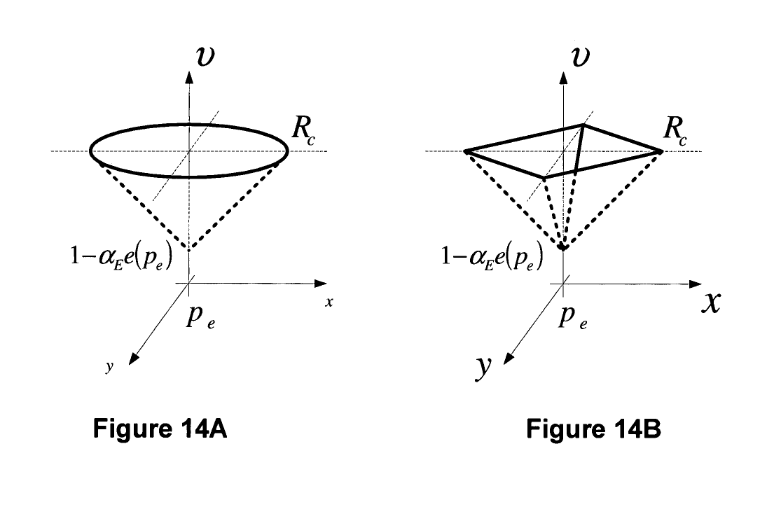

FIG. 14A shows a geometrical interpretation of the edge strength amplification using the α coefficient at a point pₑ.

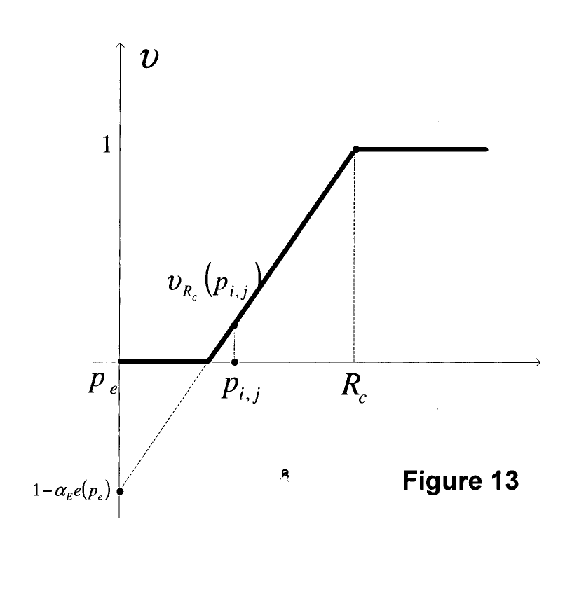

Emphasis can be put on the effect of constrained convolution by lowering this weight which is close to edge too much. This can apply even various functions which show it in FIG. 13. FIG. 13 shows a geometrical interpretation of the function of confidence weight that is defined above.

In another example of a function of the confidence weight, bilinear may be used. An advantage of the bilinear is that is faster to compute than the complicated function as shown in FIG. 14A. The bilinear function may be expressed as:

$${f}_{c} ( {p}_{i , j} ) = 1 - α \cdot e ( {p}_{e} ) \times ( 1 - \frac{\vert i \vert + \vert j \vert}{{R}_{c}} )$$

FIG. 14B shows a geometrical interpretation of the function of confidence weight that is defined above.

In another example of a function of the confidence weight, a simple form of confidence weight may be used. Here, the function may be expressed as:

$${F}_{c} ( {p}_{i , j} ) = \{ \begin{matrix}β , 0 \leq {r}_{\overline{{p}_{e} p}} < e ( {p}_{e} ) \cdot {R}_{c} \\ 1 , e ( {p}_{e} ) \cdot {R}_{c} \leq {r}_{\overline{{p}_{e} p}}\end{matrix}$$

For instance, the β is constant [0,1] or 1−e(pₑ).

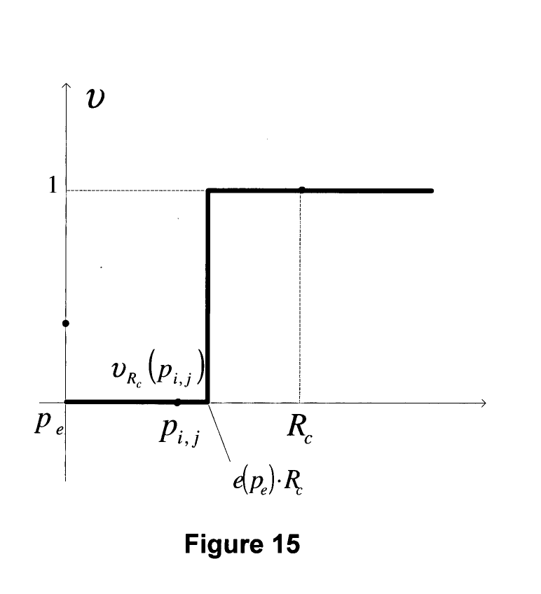

It is noted that the output becomes a little awkward in its result. FIG. 15 shows a geometrical interpretation of the function of confidence weight that is defined above.

In another example of a function of the confidence weight, a hemisphere function may be used:

$${f}_{c} ( {p}_{i , j} ) = 1 - α \cdot e ( {p}_{e} ) \times \sqrt{1 - \frac{{i}^{2} + {j}^{2}}{{R}_{c}^{2}}}$$

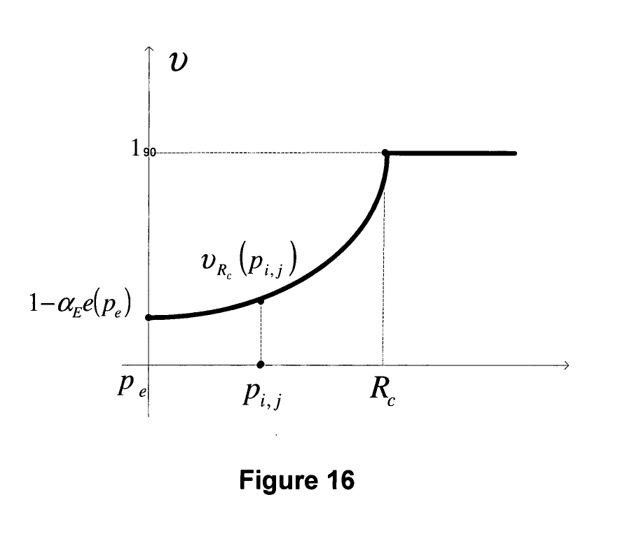

FIG. 16 shows a geometrical interpretation of the function of confidence weight that is defined above.

In another example of a function of the confidence weight, a translation of axis of the upper functions may be used. Until now, though all confidence function was lowered in proportion to e(pₑ), it is effective to translate corresponding to e(pₑ) in parallel in top and bottom, too. In other words, it may be defined as follows:
ƒ_{c}(p_{i,j})=2−g(p_{i,j})−e(pₑ)
where g(p_{i,j}) is linear, bilinear, hemisphere and others.

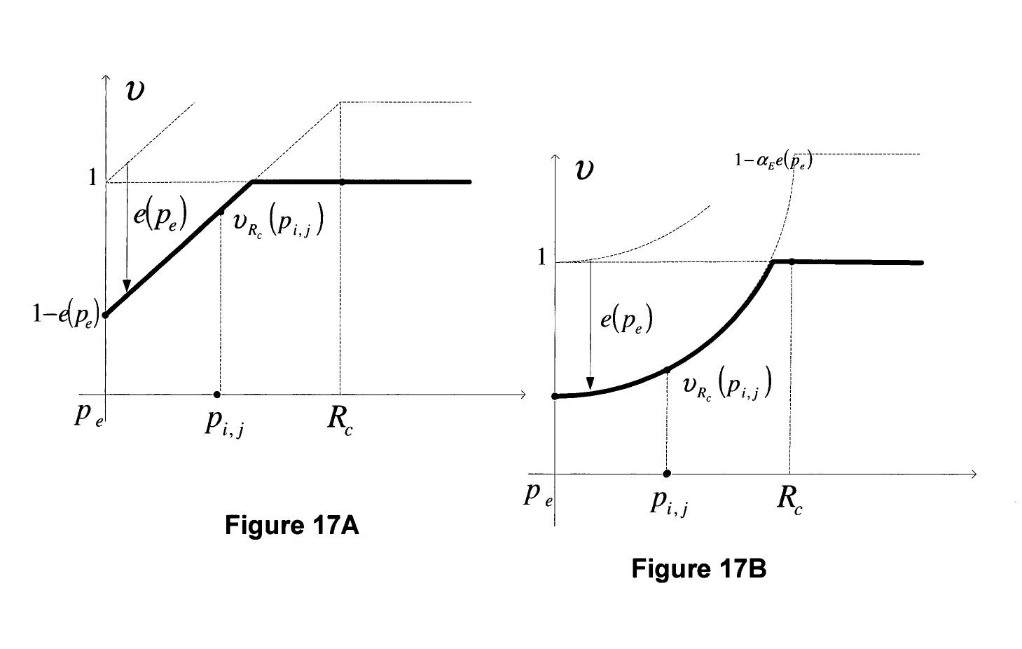

FIG. 17A and 17B show a geometrical interpretation of the function of the confidence weight that are defined above.

In another example, the edge weight may be expressed as:

$$υ ( {p}_{i , j} ) = \{ \begin{matrix}0 , 0 < {r}_{c} \leq {R}_{c} \\ 1 , {R}_{c} \leq {r}_{c}\end{matrix}$$

Here, r_{c}=|\overline{p_{i,j}p(r_{c})}| indicates a distance from a pixel p_{i,j}, which weight is given to at the coordinate of (x+i,y+j) to the nearest edge pixel p(r_{c}) which has bigger edge strength than a threshold, and R_{c} indicates a radius of an influence of edge.

In yet another example, the edge weight may be expressed as

$$υ ( {p}_{i , j} ) = \{ \begin{matrix}1 - {max}_{r ∈ R} e ( p ( {r}_{c} ) ) , 0 < {r}_{c} \leq {R}_{c} \\ 1 , {R}_{c} \leq {r}_{c}\end{matrix}$$

Here, r_{c}=|\overline{p_{i,j}p(r_{c})}| indicates a distance from a pixel p_{i,j}, which weight is given to at the coordinate of (x+i,y+j) to an edge pixel p(r_{c}), e(p(r_{c})) indicates an edge strength which consists of between 0 and 1 at a pixel p(r_{c}),R_{c} indicates the radius of the influence of edge.

Further, these confidence weights may be used or in combination.

Product of Transparency and Confidence

Another application of edge information is the product of the two functions. The first specifies that an edge information should be used to calculate a weight edge information function that assigns low weights to pixels lying on the other side an edge from the pixel whose color is being calculated. The second specifies an edge information should be used to calculate a weight edge information function that assigns low weights to pixels close to edges and high weights to pixels that are far from any edges.

This step takes as input the source image, the confidence coefficients map and the transparency coefficients and performs a convolution on each pixel that, combining all the input parameters, creates the edge sharpness image.

Given the above definition, for each pixel p₀ in the source image, ConstrainedMask_{A} is defined as corresponding to aperture Aₚ^{⁰}_{,R} and p_{i,j}εA.

$$\begin{matrix}{w}_{E} = τ ( {p}_{i , j} ) \times υ ( {p}_{i , j} ) \\ {ConstrainedMask}_{A} = \frac{τ ( {p}_{i , j} ) \times υ ( {p}_{i , j} ) \times {w}_{R} ( {p}_{i , j} )}{norm ( τ , υ , {w}_{R} )} \\ ∵ norm ( τ , υ , {w}_{R} ) = {\sum }_{i , j = - R , ⋯ , R}^{} ( τ ( {p}_{i , j} ) \times υ ( {p}_{i , j} ) \times {w}_{R} ( {p}_{i , j} ) )\end{matrix}$$

Therefore, the new color and Constrained Convolution may be defined as follows:

$$\begin{matrix}NewColor ( {p}_{0} ) = imageI * {ConstrainedMask}_{A} \\ = {\sum }_{i , j = - R , ⋯ , R}^{} \{ Color ( {p}_{i , j} ) \times \frac{τ ( {p}_{i , j} ) \times υ ( {p}_{i , j} ) \times {w}_{R} ( {p}_{i , j} )}{norm ( τ , υ , {w}_{R} )} \}\end{matrix}$$

Once a new color for pixel pₒ has been determined, this process may be repeated for the other pixels in the image.

Additional Processes

Using the above processes, one may sharpen an image and reduce jagged edges. The following show additional processes that may be used in conjugation or in place of the above.

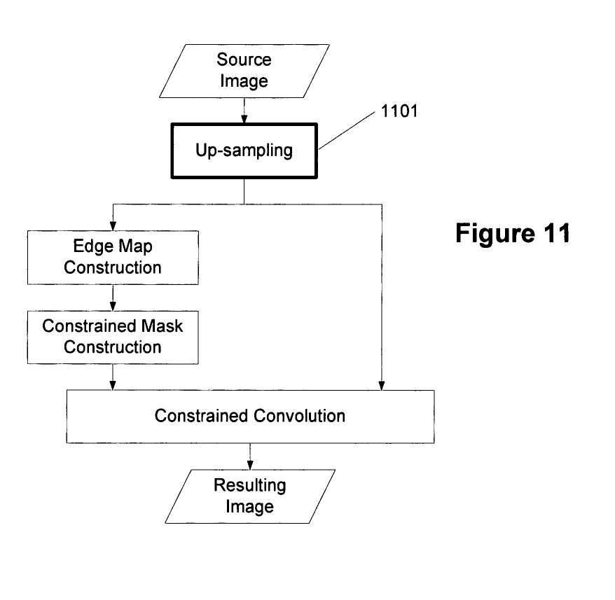

A source image may be used as shown as image 701 in FIG. 7. Alternatively, as shown in FIG. 11, an up-sampling process 1101 may be used as shown in FIG. 11. Up-sampling 1101 is effective when used with the expansion process. It preserves the quality of the original image edges in this way.

In another approach, up-sampling may be separately performed each process of edge information and color information. Here, quality may be improved more.

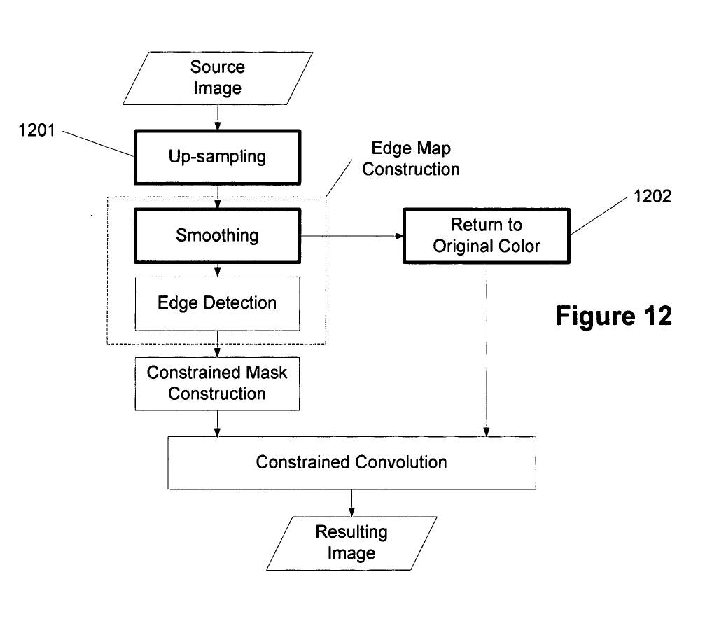

FIG. 12 shows yet another alternative approach. In the process according to separated up-sampling processes, up-sampling process 1101 and smoothing process 703 are shared by reference color information. As for the image processed with up-sampling and smoothing, the color information may change though its shape is good. So, a return to original color process may be performed more. It looks like the conversion that the image of the natural color changes in accordance with a limited color set such as 256 index colors. The color of each pixel of the image which has been expanded and smoothed is changed by the color which all the original images have. The return to original color prevents new colors from being introduced into an up-sampled image. Various return to original color processes 1201 may be used. For instance, one may review colors in various directions (radialy or in cardinal directions) from an original pixel and confine the pixel to one of the original colors found in the other pixels. Other approaches may be used including creating and referencing color histograms and the like for each pixel.

In one alternative approach, the confidence map is not made in advance. Rather, it prepares for Confidence coefficients one after another in the edge constrained convolution.

Most of the work of the various functions described herein take place along edges. Here, a jagged edge influences the color of a pixel in the position to away from edge line to a determined distance. It is the distance which the radius of an edge constrained convolution and radius of confidence function are added to. The part of the source image which is beyond the constant distance from edge line is called free domain. The edge constrained convolution becomes smoothing filter beyond this distance. Once past this distance from an edge, one may suppress the other algorithms that perform edge constrained convolution to save processing time. Alternatively, one may shrink the radius of convolution to minimize processing.

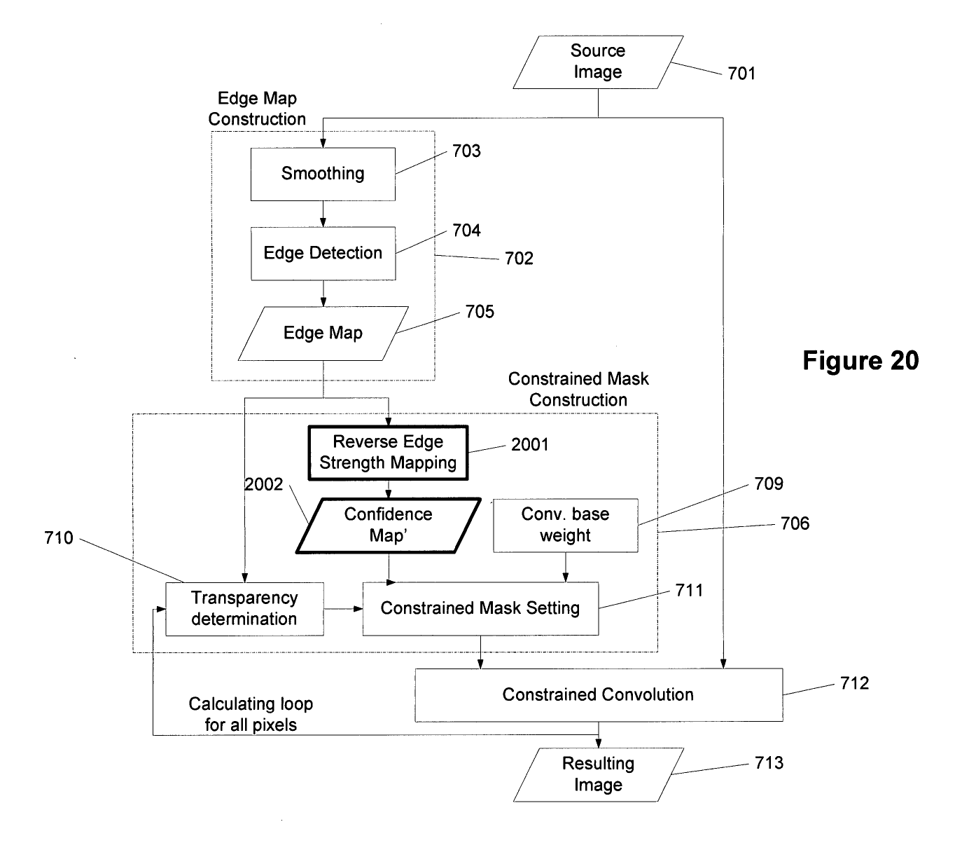

In yet another approach, the confidence map may be replaced with a confidence map' 2002 as shown in FIG. 20. Here, the confidence coefficient map' 2002 (also referred to as a reverse edge strength map) is created by a reversed edge strength mapping process 2001. If a reversed edge strength map is used instead of confidence coefficient construction, the speed-up of the process may be realized. This is because the reverse edge strength map may be determined from the edge detection step 704. An additional effect is that the resulting image 713 becomes more natural, too.

These various confidence coefficient constructions may be applied to all colors at the same time or may be applied to colors separately (for instance, applied to each component separately in an RGB system or applied to the luminance factor of a component video stream).

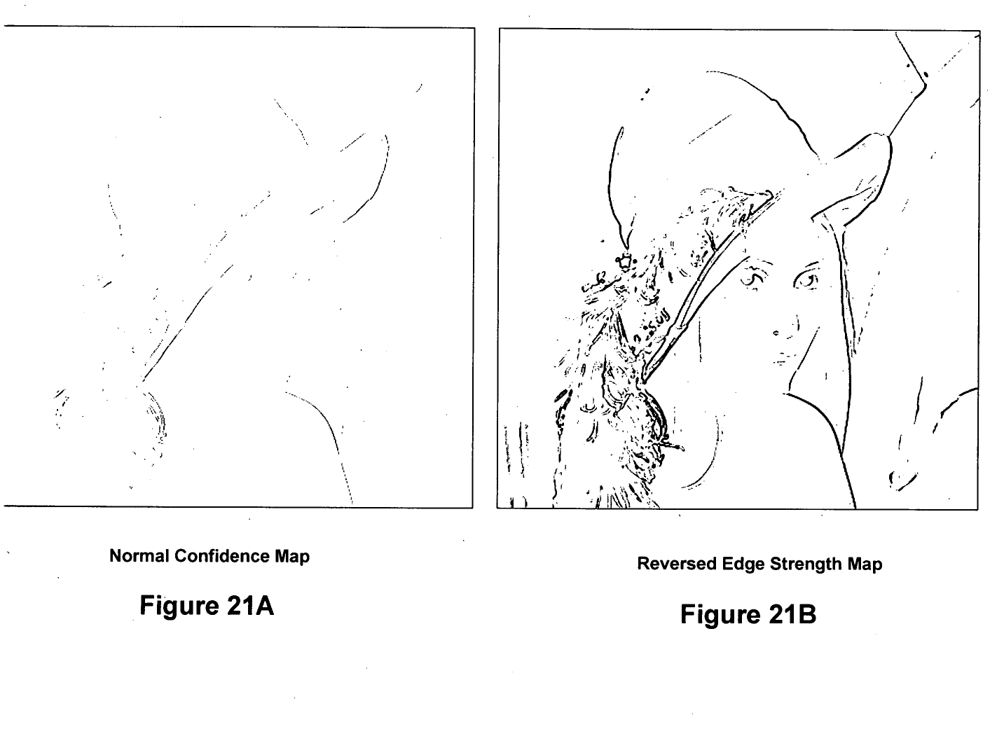

FIGS. 21A-21B show various examples of normal confidence map and reverse edge strength maps. FIG. 21A shows a normal confidence map. FIG. 21B shows a reverse edge strength map created by determining color changes based on the edge detection step 704.

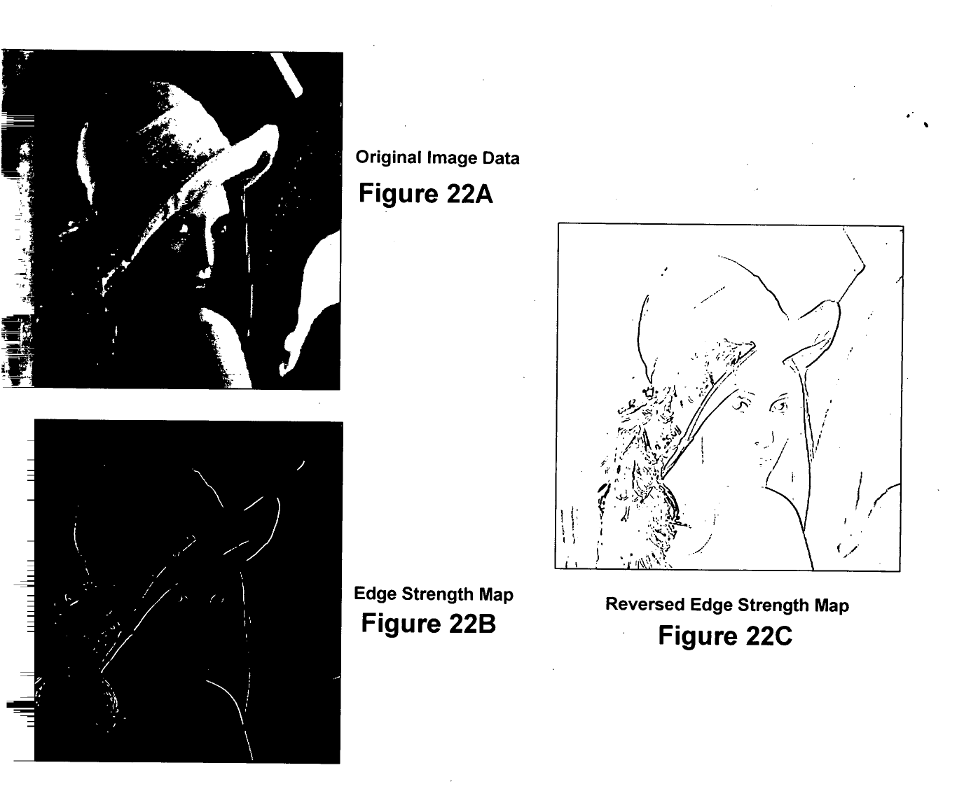

FIG. 22A shows an original image. FIG. 22B shows an edge strength map. FIG. 22C shows a reversed edge strength map. The strong region of the color changing in 22A becomes the region where the reliability of the reference color is low in 22B.

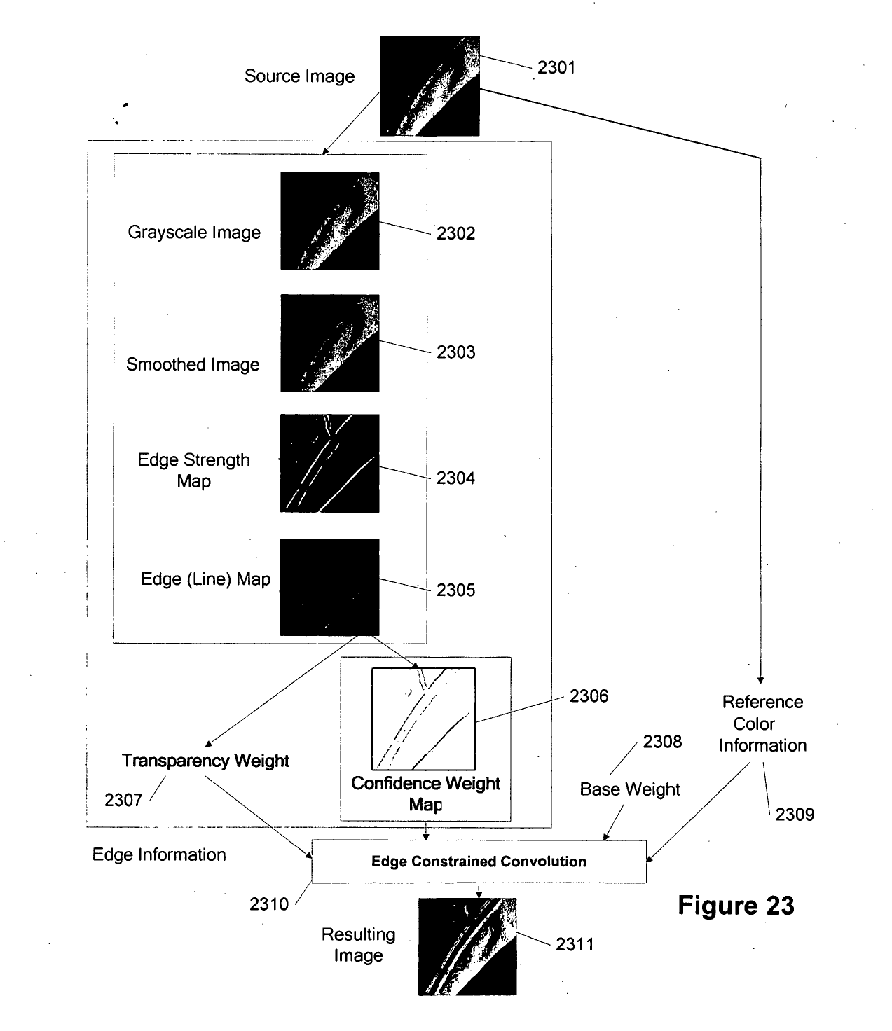

FIG. 23 shows examples of the image processes at various points in accordance with aspects of the present invention. A source image is shown as image 2301. A grayscale version of the source image is shown as 2302. A smoothed version is shown as 2303. The image resulting from the edge strength map is shown as image 2304. The edge (or line) map 2305 is shown next. These result in a confidence weight map 2306. The confidence weight map 2306 is combined with a transparency weight 2307 and a base weight 2308 and possibly color reference information 2309 in the edge constrained convolution step 2310. The result is image 2311 with less jagged edges and more lifelike colors.

Aspects of the present invention have been described above. Alternative approaches may be taken to achieve the same results. The scope of the invention follows with the appended claims.

1. A process for processing an image comprising the step of:
convolution employing edge information.

2. The process according to claim 1, where said convolution is expressed as:
$$NewColor ( {p}_{x , y} ) = {\sum }_{i , j = - R , ⋯ , R}^{} \{ Color ( {p}_{x + i , y + j} ) \times \frac{{w}_{E} ( {p}_{x + i , y + j} ) \times {w}_{R} ( {p}_{i , j} )}{norm ( {w}_{E} ( {p}_{x + i , y + j} ) , {w}_{R} ( {p}_{i , j} ) )} \}$$
where, p_{x,y} indicates a pixel of a coordinate (x,y) in an image, NewColor(p_{x,y}) indicates a color of a result image at the pixel p_{x,y}, R indicates a radius of the convolution mask, p_{i,j} indicates a pixel of coordinate (i,j)ε[−R,R] in the mask, Color(p_{x+i,y+j}) indicates a color of a source image at a pixel of p_{x+i,y+j}, w_{R}(p_{i,j}) indicates a weight of each reference color in the convolution, w_{E}(p_{x+i,y+j}) indicates a weight of an edge information, and norm(w_{E}(p_{x+i,y+j}), w_{R}(p_{i,j})) indicates a norm of w_{R}(p_{i,j}) and w_{E}(p_{x+i,y+j}).

3. The process according to claim 1, wherein said edge information should assigns low weight to each pixel lying on the other side of edges from the pixel whose color is being calculated.

4. The process according to claim 1, wherein the edge information is expressed as:
w_{E}(p_{x+i,y+j})=1−ƒ(p_{x,y},p_{x+i,y+j}, e(p))
where, p_{x,y} indicates a pixel which is regenerated by the convolution of a coordinate (x,y), p_{x+i,y+j} indicates a pixel which weight is given to of a coordinate (x+i,y+j), pε\overline{p_{x,y}p_{x+i,y+j}} indicate all pixels on a segment of a line from a pixel p_{x,y} to a pixel p_{x+i,y+j}, e(p) indicates an edge strength at a pixel p, and ƒ( ) indicates a function which is connected e(p) with distance from each center pixel p_{x,y} to a pixel p_{x+i,y+j} on monotonically increasing and the function results in values between 0 and 1.

5. The process according to claim 1, wherein said weight of said edge information is a rectangle function which has a knot at the pixel which has the maximum edge strength and where the weight is expressed as:
$$τ ( {p}_{i , j} ) = \{ \begin{matrix}1 , r \leq {r}_{e} \\ 1 - {max}_{{\_}_{p ∈ {p}_{o} {p}_{i , j}}} e ( p ) = 1 - e ( {p}_{e} ) , {r}_{e} < r \leq R\end{matrix}$$
where pε\overline{p₀p_{i,j}} indicates any pixel lying on a straight line from pixel p₀ to pixel p_{i,j}, e(p) indicates the edge strength between 0 and 1 at pixel p, pₑ⊂p indicates the pixel with maximum edge strength and e(pₑ) indicates its edge strength between 0 and 1, r=|\overline{p₀p_{i,j}}| indicates a distance metric between pixel p₀ and pixel p_{i,j}, rₑ=|\overline{p₀pₑ}| indicates a distance metric between pixel p₀ and pixel pₑ and R indicates the radius of the convolution mask.

6. The process according to claim 1, wherein said edge information assigns a low weight to each pixel close to the surrounding edge pixels.

7. The process according to claim 1, where said edge information is expressed as:
w_{E}(p_{x+i,y+j})=1−ƒ′(p_{x+i,y+j}, e(p(r_{c})))
where, p_{x+i,y+j} indicates a pixel which weight is given to of a coordinate (x+i,y+j), p(r_{c}) indicates an edge pixel which distance r_{c} from a pixel p_{x+i,y+j} of an image, e(p(r_{c})) indicates an edge strength between 0 and 1 at the pixel p(r_{c}), ƒ′( ) indicates a function which is connected e(p(r_{c})) with distance r_{c} on monotonically increasing and the function results in values between 0 and 1.

8. The process according to claim 1, wherein said weight of said edge information is a linear function which is a distance from influential edge pixels where the weight is expressed as:
$$\begin{matrix}{w}_{E} ( {p}_{x + i , y + j} ) = \{ \begin{matrix}1 - {max}_{{r}_{c} ∈ {R}_{c}} ( e ( p ( {r}_{c} ) ) \times ( 1 - \frac{{r}_{c}}{{R}_{c}} ) ) , 0 < {r}_{c} \leq {R}_{c} \\ 1 , {R}_{c} \leq {r}_{c}\end{matrix} \\ ∵ {r}_{c} = \sqrt{{i}^{2} + {j}^{2}}\end{matrix}$$
where, r_{c}=|\overline{p_{x+i,y+j}p(r_{c})}| indicates a distance from a pixel p_{x+i,y+j} which weight is given to at the coordinate of (x+i,y+j) to an edge pixel p(r_{c}), e(p(r_{c})) indicates an edge strength between 0 and 1 at a pixel p(r_{c}), and R_{c} indicates the radius of the influence of edge.

9. A process according to claim 1, wherein said edge information should assigns low weight to each pixel lying on the other side of edges from the pixel whose color is being calculated and assigns a low weight to each pixel close to the surrounding edge pixels.

10. The process according to claim 9, where said edge information is expressed as:
w_{E}(p_{x+i,y+j})={1−ƒ(p_{x,y},p_{x+i,y+j},e(p))}×{1−ƒ′(p_{x+i,y+j},e(pᵣ))}
where, p_{x,y} indicates a pixel which is regenerated by the convolution of a coordinate (x,y), p_{x+i,y+j} is a pixel which weight is given to of a coordinate (x+i,y+j), pε\overline{p_{x,y}p_{x+i,y+j}} are all pixels on a segment of a line p_{x,y} to p_{x+i,y+j}, e(p) indicates an edge strength between 0 and 1 at the pixel p, pᵣ indicates an edge pixel which distance r from the pixel p_{x+i,y+j} to the pixel pᵣ of an image, e(pᵣ) indicates an edge strength at the pixel pᵣ, ƒ( ) indicates a function which is connected e(p) with distance from the center pixel p_{x,y} to the pixel p on monotonically increasing and the function includes values between 0 and 1, and ƒ′( ) indicates a function which is connected e(pᵣ) with distance r on monotonically increasing and the function includes values between 0 and 1.

11. The process according to claim 1, further comprising a smoothing step in front of the detection of edge information.

12. The process according to claim 9, further comprising a smoothing step in front of the detection of edge information.

13. The process according to claim 1, wherein said process is used for image scaling.

14. The process according to claim 9, wherein said process is used for image scaling.

15. The process according to claims from claim 1, wherein said edge information is amplified at an amplification level before it is adapted.

16. The process according to claims from claim 9, wherein said edge information is amplified at an amplification level before it is adapted.

17. The process according to claim 1, wherein said edge information that assigns said low weight to each pixel close to the surrounding edge pixels is prepared as a map data in front of the convolution.

18. A computer-readable medium having a computer-executable program stored thereon, said program for processing an image and said program comprising the step of:
convolution employing edge information.

19. The computer-readable medium according to claim 18, where said convolution is expressed as:
$$NewColor ( {p}_{x , y} ) = {\sum }_{i , j = - R , ⋯ , R}^{} \{ Color ( {p}_{x + i , y + j} ) \times \frac{{w}_{E} ( {p}_{x + i , y + j} ) \times {w}_{R} ( {p}_{i , j} )}{norm ( {w}_{E} ( {p}_{x + i , y + j} ) , {w}_{R} ( {p}_{i , j} ) )} \}$$
where, p_{x,y} indicates a pixel of a coordinate (x,y) in an image, NewColor(p_{x,y}) indicates a color of a result image at the pixel p_{x,y}, R indicates a radius of the convolution mask, p_{i,j} indicates a pixel of coordinate (i,j)ε[−R,R] in the mask, Color(p_{x+i,y+j}) indicates a color of a source image at a pixel of p_{x+i,y+j}, w_{R}(p_{i,j}) indicates a weight of each reference color in the convolution, w_{E}(p_{x+x,y+j}) indicates a weight of an edge information, and norm(w_{E}(p_{x+i,y+j}), w_{R}(p_{i,j})) indicates a norm of w_{R}(p_{i,j}) and w_{E}(p_{x+i,y+j}).

20. The computer-readable medium according to claim 18, wherein said edge information should assigns low weight to each pixel lying on the other side of edges from the pixel whose color is being calculated.

21. The computer-readable medium according to claim 18, wherein the edge information is expressed as:
w_{E}(p_{x+i,y+j})=1−ƒ(p_{x,y}, p_{x+i,y+j},e(p))
where, p_{x,y} indicates a pixel which is regenerated by the convolution of a coordinate (x,y), p_{x+i,y+j} indicates a pixel which weight is given to of a coordinate (x+i,y+j), pε\overline{p_{x,y}p_{x+i,y+j}} indicate all pixels on a segment of a line from a pixel p_{x,y} to a pixel p_{x+i,y+j}, e(p) indicates an edge strength at a pixel p, and ƒ( ) indicates a function which is connected e(p) with distance from each center pixel p_{x,y} to a pixel p_{x+i,y+j} on monotonically increasing and the function results in values between 0 and 1.

22. The computer-readable medium according to claim 18, wherein said weight of said edge information is a rectangle function which has a knot at the pixel which has the maximum edge strength and where the weight is expressed as:
$$τ ( {p}_{i , j} ) = \{ \begin{matrix}1 , r \leq {r}_{e} \\ 1 - {max}_{{\_}_{p ∈ {p}_{o} {p}_{i , j}}} e ( p ) = 1 - e ( {p}_{e} ) , {r}_{e} < r \leq R\end{matrix}$$
where pε\overline{p₀p_{i,j}} indicates any pixel lying on a straight line from pixel p₀ to pixel p_{i,j}, e(p) indicates the edge strength between 0 and 1 at pixel p, pₑ⊂p indicates the pixel with maximum edge strength and e(pₑ) indicates its edge strength between 0 and 1, r=|\overline{p₀p_{i,j}}| indicates a distance metric between pixel p₀ and pixel p_{i,j}, rₑ=|\overline{p₀pₑ}| indicates a distance metric between pixel p₀ and pixel pₑ and R indicates the radius of the convolution mask.

23. The computer-readable medium according to claim 18, wherein said edge information assigns a low weight to each pixel close to the surrounding edge pixels.

24. The computer-readable medium according to claim 18, where said edge information is expressed as:
w_{E}(p_{x+i,y+j})=1−ƒ′(p_{x+i,y+j}, e(p(r_{c})))
where, p_{x+i,y+j} indicates a pixel which weight is given to of a coordinate (x+i,y+j), p(r_{c}) indicates an edge pixel which distance r_{c} from a pixel p_{x+i,y+j} of an image, e(p(r_{c})) indicates an edge strength between 0 and 1 at the pixel p(r_{c}), and ƒ′( ) indicates a function which is connected e(p(r_{c})) with distance r_{c} on monotonically increasing and the function results in values between 0 and 1.

25. The computer-readable medium according to claim 18, wherein said weight of said edge information is a linear function which is a distance from influential edge pixels where the weight is expressed as:
$$\begin{matrix}{w}_{E} ( {p}_{x + i , y + j} ) = \{ \begin{matrix}1 - {max}_{{r}_{c} ∈ {R}_{c}} ( e ( p ( {r}_{c} ) ) \times ( 1 - \frac{{r}_{c}}{{R}_{c}} ) ) , 0 < {r}_{c} \leq {R}_{c} \\ 1 , {R}_{c} \leq {r}_{c}\end{matrix} \\ ∵ {r}_{c} = \sqrt{{i}^{2} + {j}^{2}}\end{matrix}$$
where, r_{c}=|\overline{p_{x+i,y+j}p(r_{c})}| indicates a distance from a pixel p_{x+i,y+j} which weight is given to at the coordinate of (x+i,y+j) to an edge pixel p(r_{c}), e(p(r_{c})) indicates an edge strength between 0 and 1 at a pixel p(r_{c}), and R_{c} indicates the radius of the influence of edge.

26. The computer-readable medium according to claim 18, wherein said edge information should assigns low weight to each pixel lying on the other side of edges from the pixel whose color is being calculated and assigns a low weight to each pixel close to the surrounding edge pixels

27. The computer-readable medium according to claim 26, where said edge information is expressed as:
w_{E}(p_{x+i,y+j})={1−ƒ(p_{x,y},p_{x+i,y+j},e(p))}×{1−ƒ′(p_{x+i,y+j},e(pᵣ))}
where, p_{x,y} indicates a pixel which is regenerated by the convolution of a coordinate (x,y), p_{x+i,y+j} is a pixel which weight is given to of a coordinate (x+i,y+j), pε\overline{p_{x,y}p_{x+i,y+j}} are all pixels on a segment of a line p_{x,y} to p_{x+i,y+j}, e(p) indicates an edge strength between 0 and 1 at the pixel p, pᵣ indicates an edge pixel which distance r from the pixel p_{x+i,y+j} to the pixel pᵣ of an image, e(pᵣ) indicates an edge strength at the pixel pᵣ, ƒ( ) indicates a function which is connected e(p) with distance from the center pixel p_{x,y} to the pixel p on monotonically increasing and the function includes values between 0 and 1, and ƒ′( ) indicates a function which is connected e(pᵣ) with distance r on monotonically increasing and the function includes values between 0 and 1.

28. The computer-readable medium according to claim 18, said program further comprising a smoothing step in front of the detection of edge information.

29. The computer-readable medium according to claim 26, said program further comprising a smoothing step in front of the detection of edge information.

30. A computer-readable medium according to claim 18, wherein said program is used for image scaling.

31. A computer-readable medium according to claim 26, wherein said program is used for image scaling.

32. The computer-readable medium according to claims from claim 18, wherein said edge information is amplified at an amplification before it is adapted.

33. The computer-readable medium according to claims from claim 26, wherein said edge information is amplified at an amplification before it is adapted.

34. The computer-readable medium according to claim 18, wherein said edge information that assigns said low weight to each pixel close to the surrounding edge pixels is prepared as a map data in front of the convolution.

35. A processor processing a received image, wherein said processor including an input for receiving an image and an output for outputting a processed image, said processor performing the steps of:
edge map construction from said an image;
constrained mask construction from said an edge map;
constrained convolution based on said constrained mask; and
processing said image based on said constrained convolution.

36. A processor according to claim 35, said edge map construction performing the steps of:
smoothing at least part of said image;
edge map construction from said smoothing image; and
processing said image based on said constrained convolution.

37. A processor according to claim 35, wherein said constrained mask construction step assigns a low weight to each pixel lying on the other side of edges from the pixel whose color is being calculated processing said image.

38. A processor according to claim 35, wherein said constrained mask construction step assigns a low weight to each pixel close to the surrounding edge pixels processing said image.

39. A processor processing a received image, wherein said processor including an input for receiving an image and an output for outputting a processed image, said processor performing the steps of:
edge map construction from said an image;
constrained mask construction from said an edge map;
constrained convolution based on said constrained mask; and
processing said image based on said constrained convolution,
wherein said constrained mask construction step assigns a low weight to each pixel lying on the other side of edges from the pixel whose color is being calculated processing said image and
wherein said constrained mask construction step assigns a low weight to each pixel close to the surrounding edge pixels processing said image.

40. A processor according to claim 35, wherein said processor including an input for receiving an image performing the steps of:
up-sampling from an image;
replacing from an image to an up-sampled image;
processing said image based on said constrained convolution.

41. A processor according to claim 39, wherein said processor including an input for receiving an image performing the steps of:
up-sampling from an image;
replacing from an image to an up-sampled image;
processing said image based on said constrained convolution.
